(19) United States
(12) Patent Application Publication
(10) Pub. No.: US 2022/0217285 A1
(43) Pub. Date: Jul. 7, 2022

(54) IMAGE PROCESSING DEVICE, IMAGE PROCESSING METHOD, AND RECORDING MEDIUM

(71) Applicant: Olympus Corporation, Tokyo (JP)

(72) Inventor: Hirozumi ARAI, Tokyo (JP)

(21) Appl. No.: 17/702,666

(22) Filed: Mar. 23, 2022

Related U.S. Application Data
(63) Continuation of application No. PCT/JP2019/037848, filed on Sep. 26, 2019.

(51) Int. Cl. H04N 5/243; H04N 5/235

(52) U.S. Cl. CPC H04N 5/243; H04N 5/2351

(57) ABSTRACT

An image processing device divides an input image or a partial image that is a part of the input image into a plurality of block images, detects brightness of each of the plurality of block images, determines a brightness range to be enhanced based on brightness of each of the plurality of block images, performs gradation processing on the input image or the partial image so that brightness of a pixel having brightness included in the brightness range to be enhanced is enhanced, and outputs an image after the gradation processing.

### CROSS REFERENCE TO RELATED APPLICATIONS

This is a Continuation Application of PCT Application No. PCT/JP2019/037848, filed Sep. 26, 2019, which was not published under PCT Article 21(2) in English.

### BACKGROUND OF THE INVENTION

### Field of the Invention

The present invention relates to an image processing device, an image processing method, and a recording medium.

### Description of the Related Art

It has been conventionally known that when an astronomical object is photographed by a camera, if stars having different brightness are mixed, focusing on the second or third brightest star rather than the first brightest star may improve the finish of a photographed image as a whole.

However, when manual focusing is performed, for example, if a frame rate is increased and stars are displayed in live view on an electronic view finder (EVF) or a rear monitor of a camera, even if a live view boost function or a noise reduction function of the camera is turned on, a large amount of noise is generated in a live view image, and it may be difficult to distinguish brightness of the stars. The live view boost function is a function of facilitating confirmation of a subject such as a star by brightly displaying a live view image, and the noise reduction function is a function of removing noise from an image.

As a conventional imaging apparatus, there is known an imaging apparatus (e.g., refer to International Publication No. WO2016/181626) capable of performing an autofocus operation in photographing a scene in which a part of a bright light source is present in a background with low illuminance as a whole, such as a night sky with bright stars or a dark night view including light of a small town.

### SUMMARY OF THE INVENTION

An aspect of the present invention is an image processing device, including: a division circuit configured to divide an input image or a partial image that is a part of the input image into a plurality of block images; a detection circuit configured to detect brightness of each of the plurality of block images; a determination circuit configured to determine a brightness range to be enhanced based on brightness of each of the plurality of block images; a gradation processing circuit configured to perform gradation processing on the input image or the partial image so that brightness of a pixel having brightness included in the brightness range to be enhanced is enhanced; and an output circuit configured to output an image after the gradation processing, wherein the gradation processing circuit performs gradation processing on the input image or the partial image so that brightness of a pixel having brightness included in the brightness range to be enhanced is enhanced and brightness of a pixel having brightness not included in the brightness range to be enhanced is suppressed and so that a gradation value of a pixel having brightness included in the brightness range to be enhanced is set to a first gradation value and a gradation value of a pixel having brightness not included in the brightness range to be enhanced is set to a second gradation value (however, second gradation value<first gradation value).

Still another aspect of the present invention is an image processing method, including: dividing an input image or a partial image that is a part of the input image into a plurality of block images; detecting brightness of each of the plurality of block images; determining a brightness range to be enhanced based on brightness of each of the plurality of block images; performing gradation processing on the input image or the partial image so that brightness of a pixel having brightness included in the brightness range to be enhanced is enhanced; and outputting an image after the gradation processing, wherein the gradation processing performs gradation processing on the input image or the partial image so that brightness of a pixel having brightness included in the brightness range to be enhanced is enhanced and brightness of a pixel having brightness not included in the brightness range to be enhanced is suppressed and so that a gradation value of a pixel having brightness included in the brightness range to be enhanced is set to a first gradation value and a gradation value of a pixel having brightness not included in the brightness range to be enhanced is set to a second gradation value (however, second gradation value <first gradation value).

Still another aspect of the present invention is a non-transitory recording medium recording a program for causing a computer to execute a process, the process including: dividing an input image or a partial image that is a part of the input image into a plurality of block images; detecting brightness of each of the plurality of block images; determining a brightness range to be enhanced based on brightness of each of the plurality of block images; performing gradation processing on the input image or the partial image so that brightness of a pixel having brightness included in the brightness range to be enhanced is enhanced; and outputting an image after the gradation processing, wherein the gradation processing performs gradation processing on the input image or the partial image so that brightness of a pixel having brightness included in the brightness range to be enhanced is enhanced and brightness of a pixel having brightness not included in the brightness range to be enhanced is suppressed and so that a gradation value of a pixel having brightness included in the brightness range to be enhanced is set to a first gradation value and a gradation value of a pixel having brightness not included in the brightness range to be enhanced is set to a second gradation value (however, second gradation value<first gradation value).

### BRIEF DESCRIPTION OF THE DRAWINGS

The present invention will be more apparent from the following detailed description when the accompanying drawings are referenced.

FIG. 1 is a diagram illustrating a main configuration of an imaging apparatus according to a first embodiment.

FIG. 2 is a diagram illustrating a hardware configuration of a control unit.

FIG. 3 is a flowchart illustrating a process executed in the imaging apparatus according to the first embodiment.

FIG. 4 is a flowchart illustrating special image processing in S107.

FIG. 5 is a diagram illustrating an example of an image after normal image processing displayed on a display unit in S109.

FIG. 6 is a diagram illustrating stars represented in a partial image illustrated in FIG. 5 for each luminance range.

FIG. 7A is a diagram (part 1) illustrating a specific example of processing in S204 for determining a luminance range to be enhanced.

FIG. 7B is a diagram (part 2) illustrating a specific example of processing in S204 for determining a luminance range to be enhanced.

FIG. 7C is a diagram (part 3) illustrating a specific example of processing in S204 for determining a luminance range to be enhanced.

FIG. 8A is a diagram (part 1) illustrating a specific example of gradation processing in S205 and a specific example of a monochrome image generated in S206.

FIG. 8B is a diagram (part 2) illustrating a specific example of gradation processing in S205 and a specific example of a monochrome image generated in S206.

FIG. 8C is a diagram (part 3) illustrating a specific example of gradation processing in S205 and a specific example of a monochrome image generated in S206.

FIG. 8D is a diagram illustrating an example in which a gradation value of a pixel outside a luminance range to be enhanced need not necessarily be set to the minimum value (0) as in the examples of FIGS. 8A, 8B and 8C.

FIG. 8E is a diagram illustrating an example in which a plurality of different gradation values may be provided as gradation values of pixels in a luminance range to be enhanced.

FIG. 9 is a diagram illustrating an example in which an image in a case where normal image processing is performed and an image in a case where special image processing is performed on an image generated based on imaging data obtained by imaging the same subject field are arranged side by side.

FIG. 10 is a diagram illustrating a display example of the display unit.

FIG. 11 is a diagram illustrating a configuration of a microscope system according to a second embodiment.

FIG. 12A is a diagram (part 1) illustrating a specific example of processing similar to the processing in S204 and S205 in the special image processing illustrated in FIG. 4, which is executed in the microscope system according to the second embodiment.

FIG. 12B is a diagram (part 2) illustrating a specific example of processing similar to the processing in S204 and S205 in the special image processing illustrated in FIG. 4, which is executed in the microscope system according to the second embodiment.

FIG. 12C is a diagram (part 3) illustrating a specific example of processing similar to the processing in S204 and S205 in the special image processing illustrated in FIG. 4, which is executed in the microscope system according to the second embodiment.

FIG. 13A is a diagram (part 1) illustrating a display screen example of a display device when the same process as that illustrated in FIG. 3 (including the special image processing illustrated in FIG. 4) is executed in the microscope system according to the second embodiment.

FIG. 13B is a diagram (part 2) illustrating a display screen example of a display device when the same process as that illustrated in FIG. 3 (including the special image processing illustrated in FIG. 4) is executed in the microscope system according to the second embodiment.

FIG. 13C is a diagram (part 3) illustrating a display screen example of a display device when the same process as that illustrated in FIG. 3 (including the special image processing illustrated in FIG. 4) is executed in the microscope system according to the second embodiment.

FIG. 14 is a diagram illustrating an example of a case where a user performs manual focusing while viewing the display screen illustrated in FIG. 13C.

FIG. 15 is a diagram illustrating a hardware configuration of a computer.

### DESCRIPTION OF THE EMBODIMENTS

Embodiments of the present invention will be described below with reference to the drawings.

### First Embodiment

The apparatus according to the first embodiment is an imaging apparatus including a manual focusing function that enables a user to focus manually, and is also an imaging apparatus including an image processing device. The imaging apparatus is assumed to be a lens-integrated type or lens-interchangeable type digital camera, but the imaging apparatus including a manual focusing function may be, for example, a camera incorporated in a smartphone or a tablet terminal.

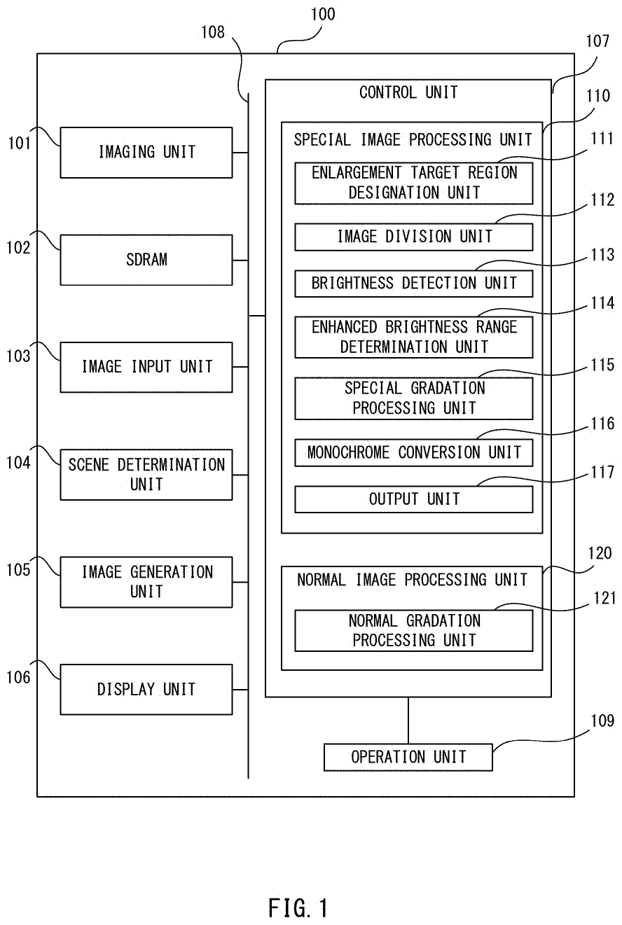

FIG. 1 is a diagram illustrating a main configuration of an imaging apparatus according to the first embodiment.

The imaging apparatus 100 illustrated in FIG. 1 includes an imaging unit 101, a synchronous dynamic random access memory (SDRAM) 102, an image input unit 103, a scene determination unit 104, an image generation unit 105, a display unit 106, and a control unit 107, each of which is connected to a bus 108. Thus, data can be transmitted and received between the units connected to the bus 108. The imaging apparatus 100 includes an operation unit 109 connected to the control unit 107.

The imaging unit 101 images a subject field and outputs imaging data. Specifically, the imaging unit 101 includes an imaging element and a signal processing unit, captures an optical image of a subject field incident via a photographic optical system (including a focus lens and others), which is not illustrated, by the imaging element, performs predetermined signal processing on an imaging signal as an imaging result by the signal processing unit, and outputs imaging data as a processing result. The imaging element is, for example, an image sensor such as a charge coupled device (CCD) or a complementary metal oxide semiconductor (CMOS). The predetermined signal processing includes gain adjustment processing and analog-to-digital (AD) conversion processing. The signal processing unit of the imaging unit 101 may be implemented by a circuit, for example. In this case, the imaging unit 101 may be configured as an imaging processing circuit including an imaging element and a signal processing circuit.

The SDRAM 102 is used as a work area or other areas of the image generation unit 105 or other units, and temporarily stores, for example, the imaging data outputted from the imaging unit 101 or image data being processed by the image generation unit 105.

The image input unit 103 is an interface to which an image is inputted, and is, for example, an interface to which a secure digital (SD) memory card or a universal serial bus (USB) memory on which an image is recorded is connected.

The scene determination unit 104 determines a subject field scene to be photographed. For example, the scene determination unit 104 determines whether or not the subject field scene to be photographed is an astronomical scene based on the imaging data outputted by imaging the subject field by the imaging unit 101.

The image generation unit 105 generates an image based on the imaging data outputted by the imaging unit 101. The image generated by the image generation unit 105 is a YCrCb image or an RGB image. In this case, each pixel has a pixel value including a luminance value (Y value) or a G component value (G value).

The display unit 106 displays various images, information, a menu screen (setting screen), and others. For example, the display unit 106 displays an image outputted by a special image processing unit 110 of the control unit 107 or an image outputted by a normal image processing unit 120 of the control unit 107. The display unit 106 is a liquid crystal display, an organic electro-luminescence (EL) display, or other displays, and may be provided as a rear monitor of the imaging apparatus 100 or may be provided as an EVF.

The control unit 107 controls each unit of the imaging apparatus 100. For example, the control unit 107 controls execution of processing in response to an instruction signal from the operation unit 109.

The control unit 107 includes a special image processing unit 110 and a normal image processing unit 120. The special image processing unit 110 is also an example of an image processing device included in the imaging apparatus 100.

The special image processing unit 110 uses the image generated by the image generation unit 105 as an input image, performs special image processing on the input image or a partial image that is a part of the input image, and outputs the processed image.

Specifically, the special image processing unit 110 includes an enlargement target region designation unit 111, an image division unit 112, a brightness detection unit 113, an enhanced brightness range determination unit 114, a special gradation processing unit 115, a monochrome conversion unit 116, and an output unit 117.

The enlargement target region designation unit 111 designates a partial region of the input image as an enlargement target region in response to an instruction signal from the operation unit 109. The partial region of the input image designated as the enlargement target region is a region corresponding to the partial image described above and is also a region enlarged and displayed by the display unit 106.

The image division unit 112 divides an input image or a partial image into a plurality of block images.

The brightness detection unit 113 detects the brightness of each of the plurality of block images divided by the image division unit 112.

For example, the brightness detection unit 113 may detect the luminance of each of the plurality of block images as the brightness of each of the plurality of block images. In this case, as the luminance of each of the plurality of block images, the average value of the luminance values (Y values) of the pixels included in the block images may be detected for each of the plurality of block images.

Alternatively, for example, the brightness detection unit 113 may detect the G component of each of the plurality of block images as the brightness of each of the plurality of block images. In this case, as the G component of each of the plurality of block images, the average value of the G component values (G values) of the pixels included in the block images may be detected for each of the plurality of block images.

The enhanced brightness range determination unit 114 determines a brightness range to be enhanced based on the brightness of each of the plurality of block images detected by the brightness detection unit 113.

For example, the enhanced brightness range determination unit 114 may specify, among the plurality of block images, a block image having brightness included in any of a plurality of different brightness ranges and being closest to the center of the input image or the partial image and determine a brightness range including the brightness of the specified block image among the plurality of brightness ranges as the brightness range to be enhanced. In the case where there is a plurality of block images having brightness included in any of a plurality of different brightness ranges and being closest to the center of the input image or the partial image, the brightness range including brightness of any one of the block images is determined as the brightness range to be enhanced. In this case, any one of the block images may be determined in accordance with a predetermined priority order, for example. The priority order may be determined based on, for example, the number of bright pixels present in one block image.

Alternatively, for example, the enhanced brightness range determination unit 114 may determine whether or not the brightness of each of the plurality of block images is included in any of a plurality of different brightness ranges, count the number of block images having brightness included in the brightness range for each brightness range of the plurality of brightness ranges, and determine any of the plurality of brightness ranges as the brightness range to be enhanced based on the number of block images for each brightness range. In this case, the brightness range having the largest number of block images among the plurality of brightness ranges may be determined as the brightness range to be enhanced. In the case where there is a plurality of brightness ranges having the largest number of block images, any one of the brightness ranges is determined as the brightness range to be enhanced. In this case, any one of the brightness ranges may be determined in accordance with a predetermined rule, for example. The rule may be, for example, a rule that the brightest brightness range is determined as the brightness range to be enhanced.

The plurality of different brightness ranges described above may be set in response to an instruction signal from the operation unit 109. In this case, the user can freely set a plurality of different brightness ranges by the operation of the operation unit 109. For example, the user can set the brightness range of a star to be focused by manual focusing as a plurality of different brightness ranges.

The special gradation processing unit 115 performs gradation processing on the input image or the partial image so that the brightness of a pixel having brightness included in the brightness range to be enhanced determined by the enhanced brightness range determination unit 114 is enhanced. In this case, the special gradation processing unit 115 may perform gradation processing on the input image or the partial image so that the brightness of a pixel having brightness included in the brightness range to be enhanced is enhanced and the brightness of a pixel having brightness not included in the brightness range to be enhanced is suppressed. For example, the special gradation processing unit 115 may perform gradation processing on the input image or the partial image so that the gradation value of a pixel having brightness included in the brightness range to be enhanced is set to a first gradation value and the gradation value of a pixel having brightness not included in the brightness range to be enhanced is set to a second gradation value (however the second gradation value<the first gradation value). The first gradation value may be set to the maximum value of a gradation range that can be expressed, and the second gradation value may be set to the minimum value of the gradation range.

The monochrome conversion unit 116 converts an image after the gradation processing by the special gradation processing unit 115 to monochrome without changing gradation to generate a monochrome image.

The output unit 117 outputs an image after the gradation processing by the special gradation processing unit 115. However, when a monochrome image is generated by the monochrome conversion unit 116, the output unit outputs the monochrome image instead of the image after the gradation processing by the special gradation processing unit 115.

The normal image processing unit 120 performs normal image processing on the image generated by the image generation unit 105 and outputs the image after the normal image processing. Specifically, the normal image processing unit 120 includes a normal gradation processing unit 121.

The normal gradation processing unit 121 performs normal gradation processing on the image generated by the image generation unit 105. The normal gradation processing is, for example, gradation processing in which a characteristic of an output (gradation) to an input (brightness) is linear.

The operation unit 109 receives the operation of the user and outputs an instruction signal corresponding to the operation to the control unit 107. Specifically, the operation unit 109 includes, for example, a power button for instructing the imaging apparatus 100 to turn on/off the power, a menu button for instructing the display unit 106 to display a menu screen, a cross key for selecting an item on the menu screen or selecting the enlargement target region described above, a confirmation button for confirming the selected item or the selected enlargement target region, and a release button for instructing photographing. Thus, the user can set, for example, an astronomical mode as a photographing mode, set whether or not to perform the special image processing regardless of the set photographing mode, or designate an enlargement target region, by the operation of the operation unit 109. The operation unit 109 may further include a touch panel. In this case, the touch panel is disposed on, for example, a rear monitor serving as the display unit 106.

In the imaging apparatus 100 illustrated in FIG. 1, the scene determination unit 104 and the image generation unit 105 may be implemented by a circuit. The scene determination unit 104 and the image generation unit 105 may be configured as a part of the control unit 107.

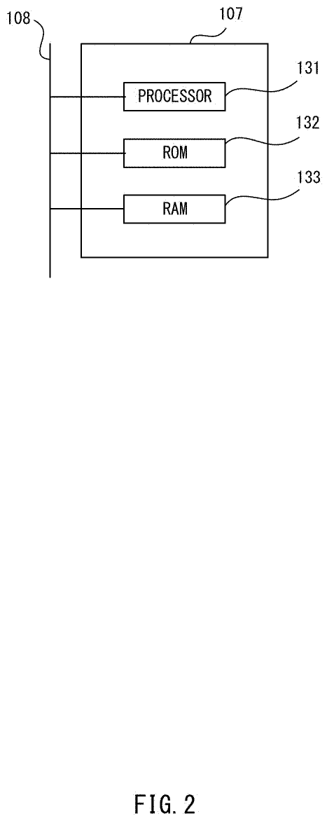

FIG. 2 is a diagram illustrating a hardware configuration of the control unit 107.

The control unit 107 illustrated in FIG. 2 includes a processor 131, a read only memory (ROM) 132, and a random access memory (RAM) 133, each of which is connected to the bus 108.

The processor 131 is, for example, a central processing unit (CPU), and realizes the function of the control unit 107 described above by reading and executing a program stored in the ROM 132. The ROM 132 stores programs to be executed by the processor 131 as well as data necessary for executing the programs. The RAM 133 is used as a work area or other areas of the processor 131.

The control unit 107 is not limited to the hardware configuration illustrated in FIG. 2, and may be implemented by an integrated circuit such as an application specific integrated circuit (ASIC) or a field programmable gate array (FPGA).

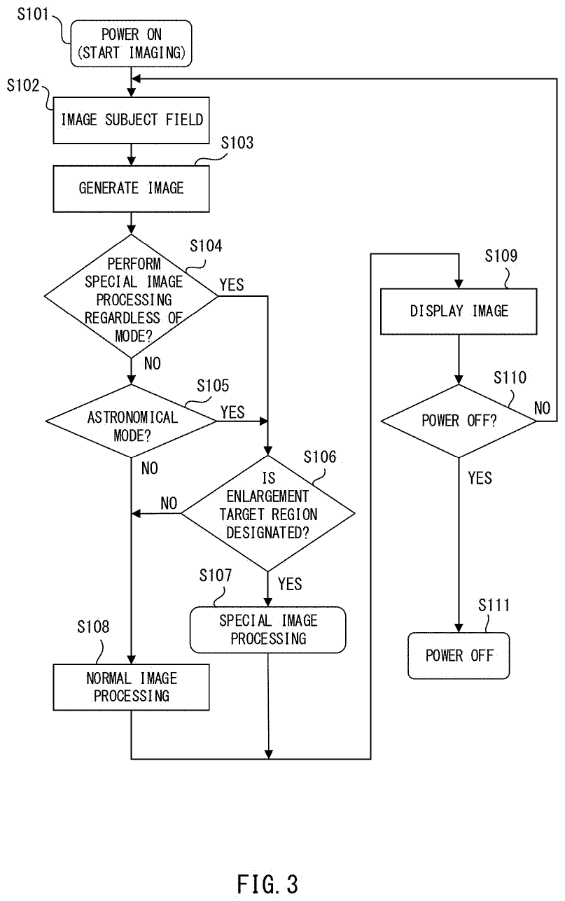

FIG. 3 is a flowchart illustrating a process executed in the imaging apparatus 100 according to the first embodiment. This process is also a process used to facilitate manual focusing on a star of a specific brightness when performing astrophotography.

In the process illustrated in FIG. 3, when a power-on instruction signal is inputted by a user's operation of the operation unit 109 (pressing of a power button), the control unit 107 turns on the power of the imaging apparatus 100 (S101) and the imaging unit 101 starts imaging. The imaging unit 101 then images the subject field and outputs the imaging data (S102), and the image generation unit 105 generates an image based on the imaging data (S103).

The control unit 107 then determines whether or not the special image processing is set to be performed regardless of the set photographing mode (S104).

If the determination result in S104 is NO, the control unit 107 determines whether or not the astronomical mode is set as the photographing mode (S105).

If the determination result in S104 is YES or if the determination result in S105 is YES, the control unit 107 determines whether or not an enlargement target region is designated (S106).

The enlargement target region can be freely designated by the user by the operation of the operation unit 109. For example, a rectangular frame for designating an enlargement target region is superimposed and displayed on an image after normal image processing to be discussed below displayed on the display unit 106, and the user moves the rectangular frame to a desired position by operation of the operation unit 109 and confirms the rectangular frame, whereby a region in the rectangular frame at the position is designated as the enlargement target region.

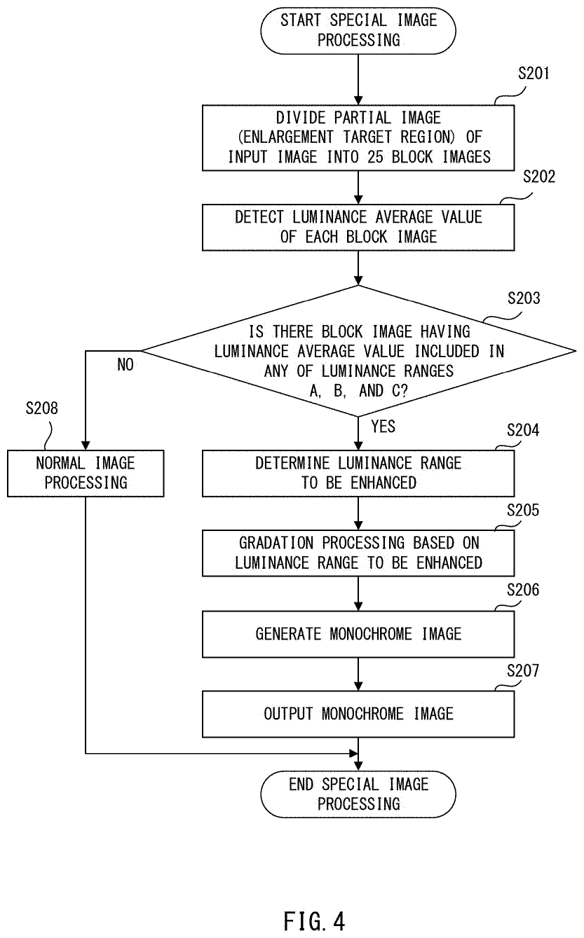

If the determination result in S106 is YES, the special image processing unit 110 uses the image generated by the image generation unit 105 in S103 as an input image, performs special image processing on a partial image corresponding to the designated enlargement target region of the input image, and outputs the image after the special image processing (S107). Details of the processing in S107 will be discussed below with reference to FIG. 4.

If the determination result in S105 is NO or if the determination result in S106 is NO, the normal image processing unit 120 performs normal image processing on the image generated by the image generation unit 105 in S103, and outputs the image after the normal image processing (S108).

After S107 or S108, the display unit 106 performs enlarged display of the image after the special image processing outputted in S107 or display of the image after the normal image processing outputted in S108 (S109).

The control unit 107 then determines whether or not a power-off instruction signal is inputted by the user's operation of the operation unit 109 (pressing of the power button) (S110).

If the determination result in S110 is NO, the process returns to S102. Thus, while the determination result in S110 is NO, the processing of S102 to S109 is repeatedly performed, and the display unit 106 performs, as live view display, enlarged display of the image after the special image processing or display of the image after the normal image processing.

If the determination result in S110 is YES, the control unit 107 turns off the power of the imaging apparatus 100 (S111).

FIG. 4 is a flowchart illustrating the special image processing in S107.

In the special image processing illustrated in FIG. 4, first, an image generated by the image generation unit 105 in S103 is used as an input image, and the image division unit 112 divides a partial image corresponding to the designated enlargement target region of the input image into a plurality of block images (S201). It is assumed here that the image is divided into 25 (=5×5) block images.

The brightness detection unit 113 then detects the brightness of each of the 25 block images divided by the image division unit 112 in S201 (S202). It is assumed here that as the brightness of each of the 25 block images, the average value of the luminance values of the pixels included in the block images (hereinafter referred to as “luminance average value”) is detected for each of the 25 block images.

The enhanced brightness range determination unit 114 then determines a luminance range to be enhanced (an example of a brightness range) based on the luminance average value of each block image detected by the brightness detection unit 113 in S202 (S203 and S204).

Specifically, the enhanced brightness range determination unit 114 first determines whether there is a block image having a luminance average value included in any of a plurality of different luminance ranges among the 25 block images (S203). It is assumed here that the luminance value of the pixel is represented by 8 bits (0 to 255), and the plurality of different luminance ranges is a luminance range A in which the luminance value is in a range of 80 to 100, a luminance range B in which the luminance value is in a range of 101 to 120, and a luminance range C in which the luminance value is in a range of 121 to 160.

If the determination result in S203 is YES, the enhanced brightness range determination unit 114 specifies, among the 25 block images, a block image having a luminance average value included in any of the luminance ranges A, B, and C and being closest to the center of the partial image described above, and determines a luminance range including the luminance average value of the specified block image among the luminance ranges A, B, and C as a luminance range to be enhanced (S204).

After S204, the special gradation processing unit 115 performs gradation processing on the partial image described above so that the luminance (an example of brightness) of a pixel having a luminance value included in the luminance range to be enhanced determined by the enhanced brightness range determination unit 114 in S204 is enhanced and the luminance of a pixel having a luminance value not included in the luminance range to be enhanced is suppressed (S205). It is assumed here that the gradation value of a pixel is represented by 8 bits (0 to 255), and gradation processing is performed on the partial image described above so that the gradation value of the pixel having the luminance value included in the luminance range to be enhanced is set to the maximum value (255) and the gradation value of the pixel having the luminance value not included in the luminance range to be enhanced is set to the minimum value (0).

After S205, the monochrome conversion unit 116 converts an image after the gradation processing performed by the special gradation processing unit 115 in S205 to monochrome without changing gradation to generate a monochrome image (S206).

After S206, the output unit 117 outputs the monochrome image generated by the monochrome conversion unit 116 in S206 (S207).

If the determination result in S203 is NO, the special image processing unit 110 does not perform subsequent processing after S204, and instead, the normal image processing unit 120 performs normal image processing in the same manner as in S108 (S208).

After S207 or S208, the special image processing illustrated in FIG. 4 is completed, and the process returns to that illustrated in FIG. 3.

The process illustrated in FIG. 3 (including the special image processing illustrated in FIG. 4) will be further described with specific examples.

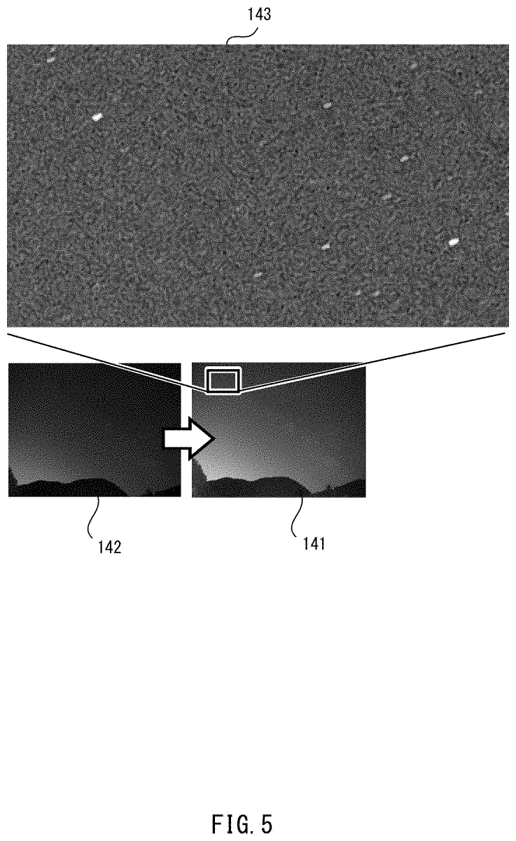

FIG. 5 is a diagram illustrating an example of an image after normal image processing displayed on the display unit 106 in S109. However, in this example, it is assumed that processing by a live view boost function is also executed as a part of the normal image processing.

The image 141 after the normal image processing illustrated in FIG. 5 is an image obtained by imaging a subject field 142, and is an image in which a large amount of noise is generated as illustrated in a partial image 143 in which a part of the image 141 is enlarged. Therefore, it is not easy for the user to perform manual focusing on a star of a specific brightness while viewing the image 141 (or the partial image 143).

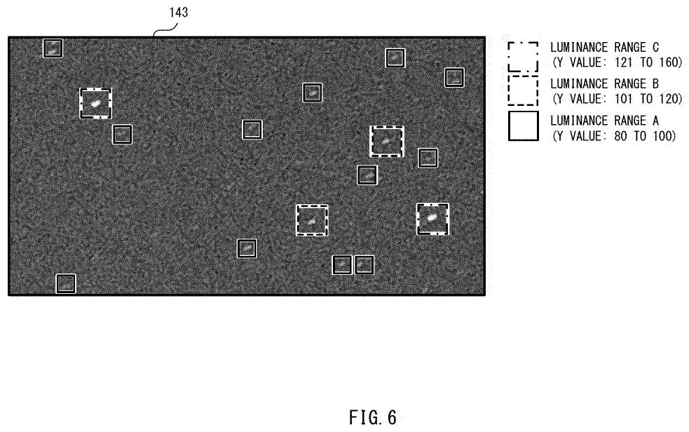

FIG. 6 is a diagram illustrating stars represented in the partial image 143 illustrated in FIG. 5 for each luminance range.

In FIG. 6, stars illustrated in a solid line frame indicate stars having luminance included in the luminance range A, stars illustrated in a broken line frame indicate stars having luminance included in the luminance range B, and stars illustrated in a dashed-and-dotted line frame indicate stars having luminance included in the luminance range C.

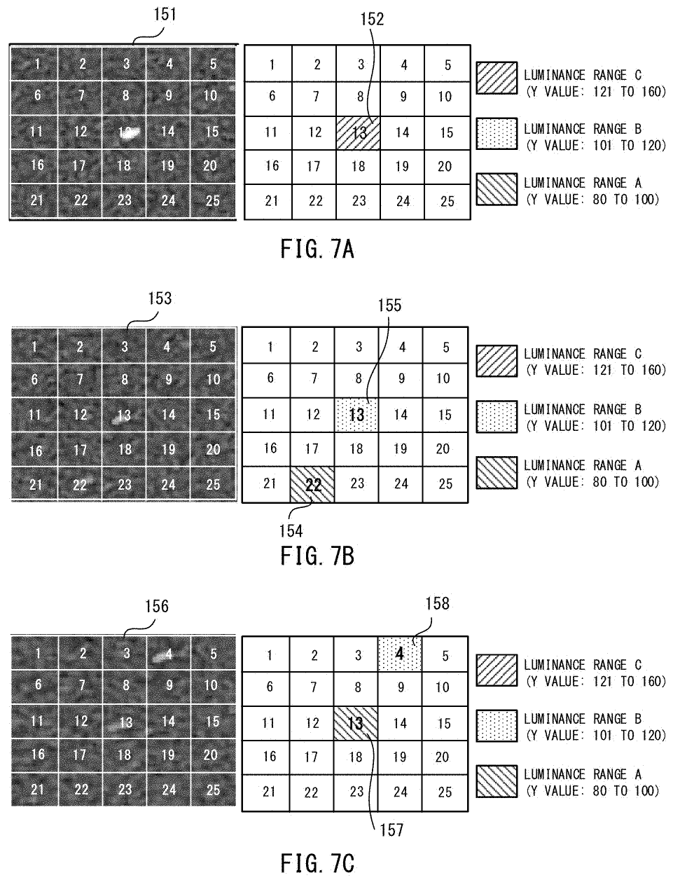

FIGS. 7A, 7B, and 7C are diagrams illustrating specific examples of processing in S204 for determining a luminance range to be enhanced.

The example illustrated in FIG. 7A is an example of a case where, in 25 block images in a partial image 151, there is no block image having a luminance average value included in the luminance range A or the luminance range B, and the block image having a luminance average value included in the luminance range C is only a block image 152. In this case, among the 25 block images in the partial image 151, the block image 152 is specified as a block image having a luminance average value included in any of the luminance ranges A, B, and C and being closest to the center of the partial image 151, and the luminance range C including the luminance average value of the specified block image 152 is determined as a luminance range to be enhanced.

The example illustrated in FIG. 7B is an example of a case where, in 25 block images in a partial image 153, the block image having a luminance average value included in the luminance range A is only a block image 154, the block image having a luminance average value included in the luminance range B is only a block image 155, and there is no block image having a luminance average value included in the luminance range C. In this case, among the 25 block images in the partial image 153, the block image 155 is specified as a block image having a luminance average value included in any of the luminance ranges A, B, and C and being closest to the center of the partial image 153, and the luminance range B including the luminance average value of the specified block image 155 is determined as a luminance range to be enhanced.

The example illustrated in FIG. 7C is an example of a case where, in 25 block images in a partial image 156, the block image having a luminance average value included in the luminance range A is only a block image 157, the block image having a luminance average value included in the luminance range B is only a block image 158, and there is no block image having a luminance average value included in the luminance range C. In this case, among the 25 block images in the partial image 156, the block image 157 is specified as a block image having a luminance average value included in any of the luminance ranges A, B, and C and being closest to the center of the partial image 156, and the luminance range A including the luminance average value of the specified block image 157 is determined as a luminance range to be enhanced.

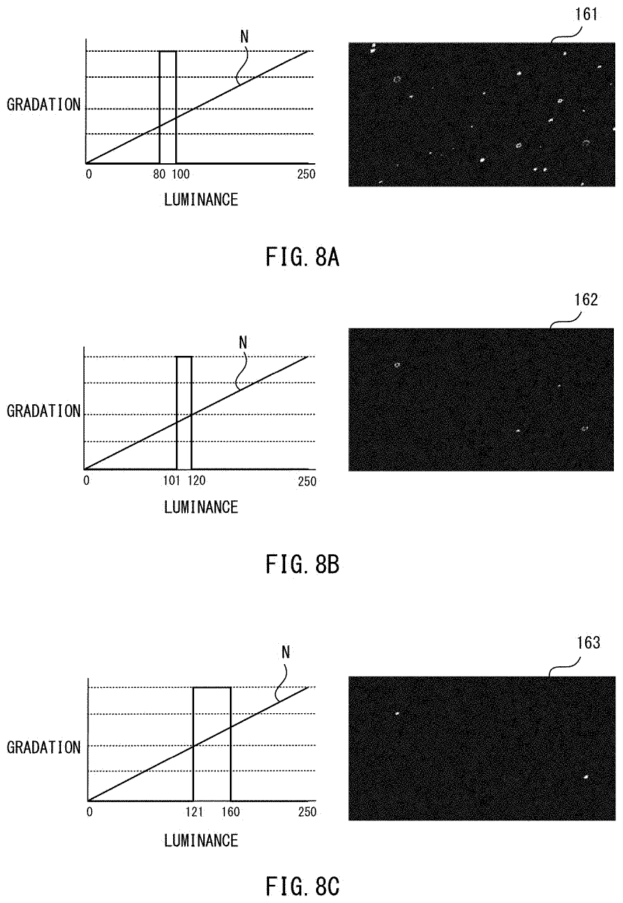

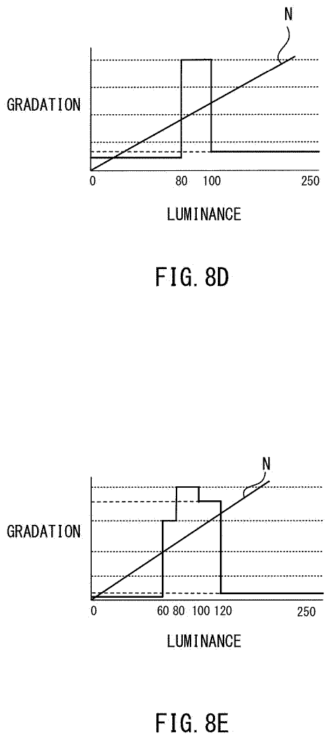

FIGS. 8A, 8B, and 8C are diagrams illustrating specific examples of gradation processing in S205 and specific examples of monochrome images generated in S206. However, in the example of each drawing, it is assumed that the partial image corresponds to the partial image 143 illustrated in FIGS. 5 and 6.

The example illustrated in FIG. 8A is an example of a case where the luminance range to be enhanced is set to the luminance range A (the luminance value is in a range of 80 to 100), and in this case, gradation processing is performed on the partial image so that the gradation value of the pixel having the luminance value included in the luminance range A is set to the maximum value (255) and the gradation value of the pixel having the luminance value not included in the luminance range A is set to the minimum value (0). The processed image is then converted to monochrome without changing gradation to generate a monochrome image 161.

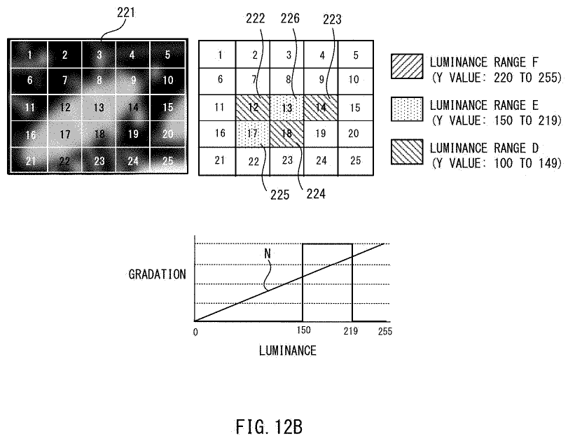

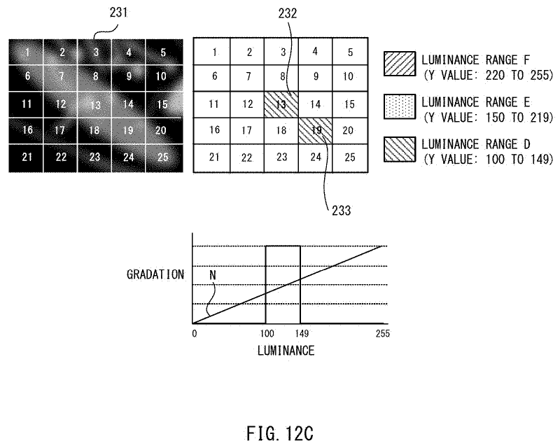

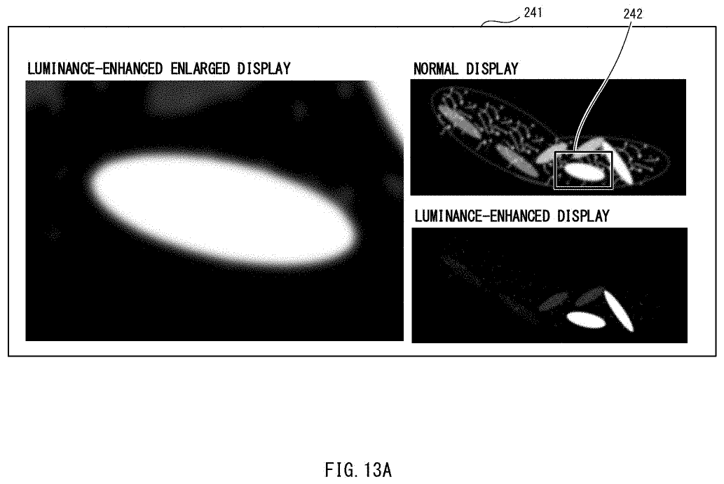

In normal gradation processing, the characteristics of the output (gradation) relative to the input (in this case, luminance) are linear (refer to a straight line N, and the same applies to FIGS. 8B, 8C, 8D, 8E, 12A, 12B, and 12C).

The example illustrated in FIG. 8B is an example of a case where the luminance range to be enhanced is set to the luminance range B (the luminance value is in a range of 101 to 120), and in this case, gradation processing is performed on the partial image so that the gradation value of the pixel having the luminance value included in the luminance range B is set to the maximum value (255) and the gradation value of the pixel having the luminance value not included in the luminance range B is set to the minimum value (0). The processed image is then converted to monochrome without changing gradation to generate a monochrome image 162.

The example illustrated in FIG. 8C is an example of a case where the luminance range to be enhanced is set to the luminance range C (the luminance value is in a range of 121 to 160), and in this case, gradation processing is performed on the partial image so that the gradation value of the pixel having the luminance value included in the luminance range C is set to the maximum value (255) and the gradation value of the pixel having the luminance value not included in the luminance range C is set to the minimum value (0). The processed image is then converted to monochrome without changing gradation to generate a monochrome image 163.

FIG. 8D is a diagram illustrating an example in which a gradation value of a pixel outside a luminance range to be enhanced need not necessarily be set to the minimum value (0) as in the examples described above of FIGS. 8A, 8B and 8C. As illustrated in the example of FIG. 8D, a plurality of different gradation values may be provided as gradation values of pixels outside the luminance range to be enhanced. In this example, a gradation value of a pixel having a luminance value of 0 to 79 and a gradation value of a pixel having a luminance value of 101 to 255 are provided as gradation values of pixels outside the luminance range to be enhanced, and the latter gradation value is higher than the former gradation value.

FIG. 8E is a diagram illustrating an example in which a plurality of different gradation values may be provided as gradation values of pixels in a luminance range to be enhanced. In this example, a gradation value of a pixel having a luminance value of 60 to 79, a gradation value of a pixel having a luminance value of 80 to 99, and a gradation value of a pixel having a luminance value of 100 to 119 are provided as gradation values of pixels in a luminance range to be enhanced. The gradation value of a pixel having a luminance value of 80 to 99 is set to the maximum value (255), the gradation value of a pixel having a luminance value of 60 to 79 and the gradation value of a pixel having a luminance value of 100 to 119 are set to be less than the maximum value, and the gradation value of a pixel having a luminance value of 100 to 119 is higher than the gradation value of a pixel having a luminance value of 60 to 79.

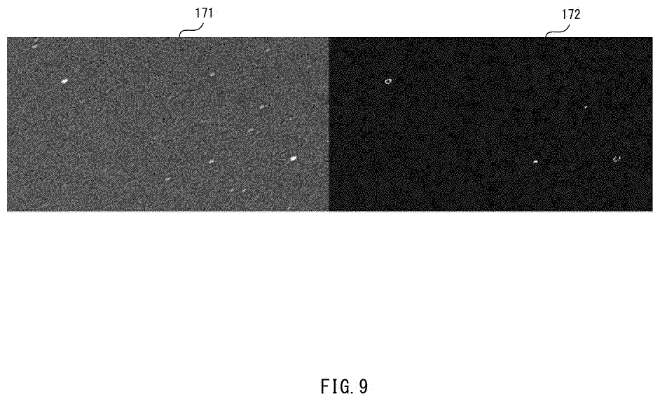

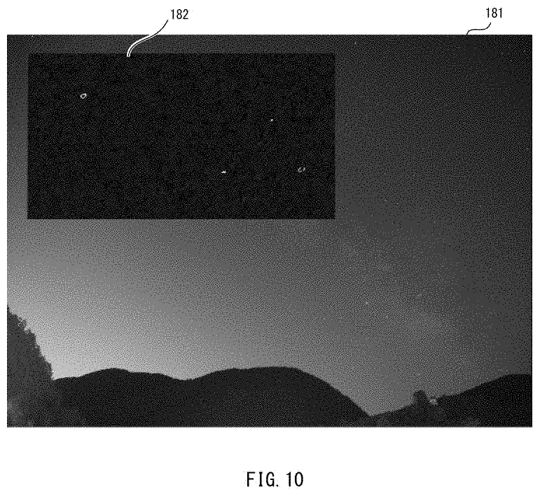

FIG. 9 is a diagram illustrating an example in which an image in a case where normal image processing is performed and an image in a case where special image processing is performed on an image generated based on imaging data obtained by imaging the same subject field are arranged side by side.

In FIG. 9, an image 171 in a case where the normal image processing is performed is also the partial image 153 illustrated in FIG. 5, and an image 172 after the special image processing is also the monochrome image 162 illustrated in FIG. 8B.

As illustrated in FIG. 9, in the image 171 in a case where normal image processing is performed, manually focusing on a star of a specific brightness is difficult due to a large amount of noise, but in the image 172 in a case where special image processing is performed, pixels having a specific brightness (in this case, brightness corresponding to the luminance range B) are represented in white, and pixels having other brightness are represented in black, so that stars represented by pixels having a specific brightness, that is, stars of a specific brightness can be distinguished.

As described above, according to the first embodiment, the user can display an image after the special image processing (e.g., the image 172 illustrated in FIG. 9) on the display unit 106 by setting the special image processing regardless of the set photographing mode and designating the enlargement target region or by setting the astronomical mode as the photographing mode and designating the enlargement target region, when performing astrophotography, so that the stars of a specific brightness can be distinguished and manual focusing on the star can be easily performed.

The present embodiment can have the following modifications.

For example, the present embodiment may be configured such that the user can set whether to generate a monochrome image by the operation of the operation unit 109. In this case, when a setting is made not to generate a monochrome image, S206 is skipped in the special image processing illustrated in FIG. 4, and in S207, an image after gradation processing is performed by the special gradation processing unit 115 in S205 is outputted by the output unit 117.

For example, in the process illustrated in FIG. 3, the special image processing in S107 may be executed only when the scene determination unit 104 determines that the subject field scene to be photographed is an astronomical scene. In other words, it can be said that the image processing device provided in the imaging apparatus 100 operates only when the scene determination unit 104 determines that the subject field scene to be photographed is an astronomical scene.

For example, in the process illustrated in FIG. 3, even if the enlargement target region is not designated (even if the determination result in S106 is NO), the process may proceed to S107. In this case, in the special image processing illustrated in FIG. 4, the same processing may be performed not on a partial image but on an input image (an image generated by the image generation unit 105).

For example, when the special image processing in S107 is performed in the process illustrated in FIG. 3, the normal image processing in S108 may also be performed in parallel. In this case, in S109, the image after the special image processing outputted in S107 may be enlarged and superimposed on the image after the normal image processing outputted in S108 and may be displayed on the display unit 106.

FIG. 10 is a diagram illustrating a display example of the display unit 106 at the time of the display.

The display example illustrated in FIG. 10 is a display example in which an image 182 after the special image processing is enlarged and superimposed on an image 181 after the normal image processing. The image 181 after the normal image processing is also the image 141 after the normal image processing illustrated in FIG. 5, and the image 182 after the special image processing is also the image 172 after the special image processing illustrated in FIG. 9 (or the monochrome image 162 illustrated in FIG. 8B).

For example, in the process illustrated in FIG. 3, when the special image processing in S107 is performed and the normal image processing in S108 is also performed in parallel, the image after the special image processing and the image after the normal image processing, or the image after the special image processing (e.g., the image 172 illustrated in FIG. 9) and the partial image (e.g., the image 171 illustrated in FIG. 9), which is a part of the image after the normal image processing and corresponds to the image after the special image processing, may be alternately displayed in S109.

For example, in the process illustrated in FIG. 3, in the special image processing in S107, processing may be performed using an image inputted to the image input unit 103 as an input image instead of an image generated by the image generation unit 105.

### Second Embodiment

An apparatus according to a second embodiment is a microscope system including a manual focusing function that enables a user to focus manually, and is also a microscope system including an image processing device.

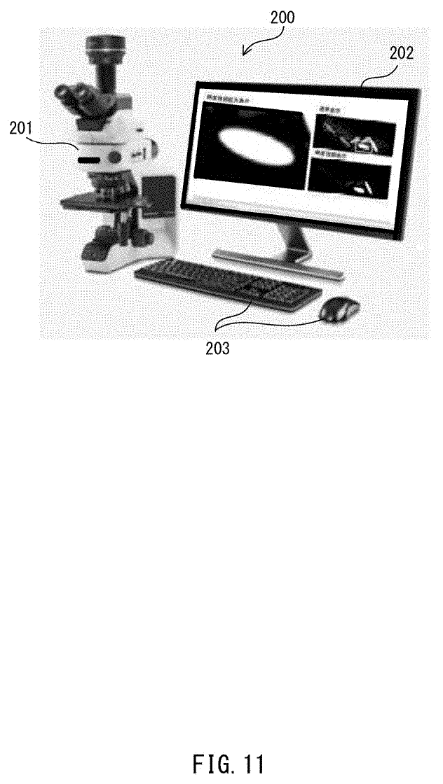

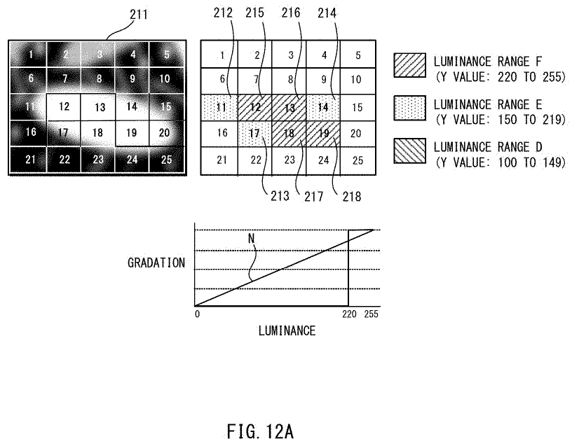

FIG. 11 is a diagram illustrating a configuration of a microscope system according to the second embodiment.

The microscope system 200 according to the second embodiment illustrated in FIG. 11 includes a microscope main body 201, a display device 202, and an input device 203.

Although not illustrated, the microscope main body 201 includes a control unit that controls each unit of the microscope system 200, and a configuration having the same functions as those of the imaging unit 101, the SDRAM 102, the image input unit 103, and the image generation unit 105 illustrated in FIG. 1. The control unit of the microscope main body 201 has the same functions as those of the special image processing unit 110 and the normal image processing unit 120 illustrated in FIG. 1. The function of the control unit of the microscope main body 201 similar to that of the special image processing unit 110 illustrated in FIG. 1 is also an example of the image processing device included in the microscope system 200.

The display device 202 is, for example, a liquid crystal display or an organic EL display, and has the same function as that of the display unit 106 illustrated in FIG. 1.

The input device 203 is, for example, a mouse or a keyboard, and has the same function as that of the operation unit 109 illustrated in FIG. 1.

The microscope system 200 according to the second embodiment having such a configuration can perform the same process as that illustrated in FIG. 3 (including the special image processing illustrated in FIG. 4) in order to easily perform manual focusing on an observation site of a specific brightness when performing fluorescence observation. However, in this case, the “photographing mode” is replaced with the “observation mode”, and the “astronomical mode” is replaced with the “fluorescence observation mode” to perform processing.

FIGS. 12A, 12B, and 12C are diagrams illustrating specific examples of processing similar to the processing in S204 and S205 in the special image processing illustrated in FIG. 4, which is executed in the microscope system 200 according to the second embodiment. However, it is assumed here that a plurality of different luminance ranges is a luminance range D in which the luminance value is in a range of 100 to 149, a luminance range E in which the luminance value is in a range of 150 to 219, and a luminance range F in which the luminance value is in a range of 220 to 255. It is also assumed here that the luminance value of the pixel is represented by 8 bits (0 to 255).

The example illustrated in FIG. 12A is an example of a case where, in 25 block images in a partial image 211, there is no block image having a luminance average value included in the luminance range D, the block images having luminance average values included in the luminance range E are three block images 212, 213, and 214, and the block images having luminance average values included in the luminance range F are four block images 215, 216, 217, and 218. In this case, among the 25 block images in the partial image 211, the block image 216 is specified as a block image having a luminance average value included in any of the luminance ranges D, E, and F and being closest to the center of the partial image 211, and the luminance range F including the luminance average value of the specified block image 216 is determined as a luminance range to be enhanced. Gradation processing is then performed on the partial image 211 so that the gradation value of the pixel having the luminance value included in the luminance range F is set to the maximum value (255) and the gradation value of the pixel having the luminance value not included in the luminance range F is set to the minimum value (0).

The example illustrated in FIG. 12B is an example of a case where, in 25 block images in a partial image 221, the block images having luminance average values included in the luminance range D are three block images 222, 223, and 224, the block images having luminance average values included in the luminance range E are two block images 225 and 226, and there is no block image having a luminance average value included in the luminance range F. In this case, among the 25 block images in the partial image 221, the block image 226 is specified as a block image having a luminance average value included in any of the luminance ranges D, E, and F and being closest to the center of the partial image 221, and the luminance range E including the luminance average value of the specified block image 226 is determined as a luminance range to be enhanced. Gradation processing is then performed on the partial image 221 so that the gradation value of the pixel having the luminance value included in the luminance range E is set to the maximum value (255) and the gradation value of the pixel having the luminance value not included in the luminance range E is set to the minimum value (0).

The example illustrated in FIG. 12C is an example of a case where, in 25 block images in a partial image 231, the block images having luminance average values included in the luminance range D are two block images 232 and 233, and there is no block image having a luminance average value included in the luminance range E or the luminance range F. In this case, among the 25 block images in the partial image 231, the block image 232 is specified as a block image having a luminance average value included in any of the luminance ranges D, E, and F and being closest to the center of the partial image 231, and the luminance range D including the luminance average value of the specified block image 232 is determined as a luminance range to be enhanced. Gradation processing is then performed on the partial image 231 so that the gradation value of the pixel having the luminance value included in the luminance range D is set to the maximum value (255) and the gradation value of the pixel having the luminance value not included in the luminance range D is set to the minimum value (0).

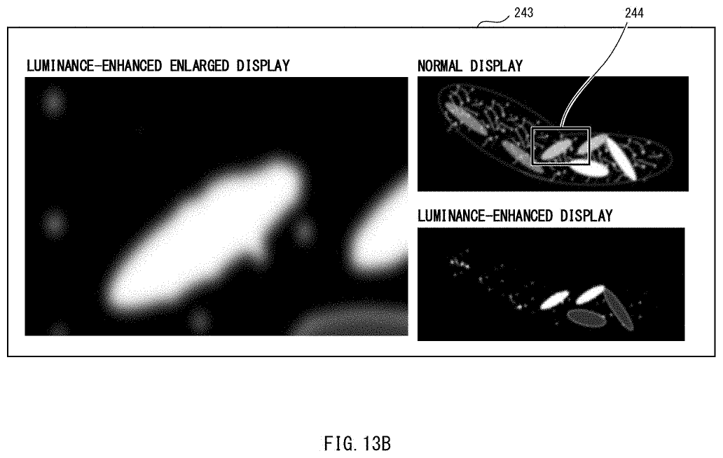

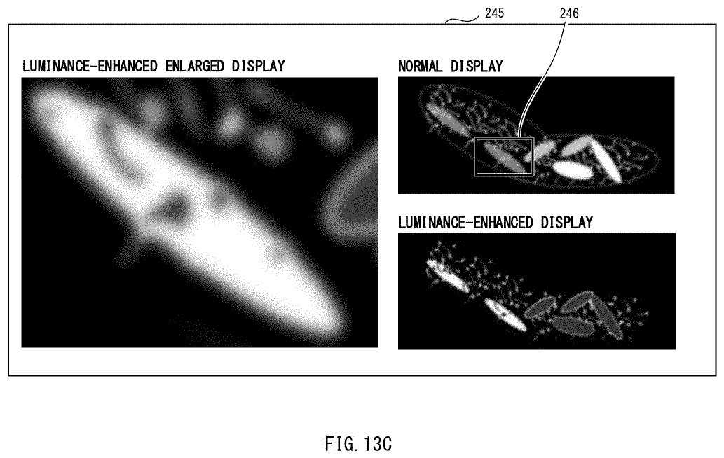

FIGS. 13A, 13B, and 13C are diagrams illustrating display screen examples of the display device 202 when the same process as that illustrated in FIG. 3 (including the special image processing illustrated in FIG. 4) is executed in the microscope system 200 according to the second embodiment.

However, it is assumed here that the same processing as the special image processing in S107 is executed in the same process as that illustrated in FIG. 3. In such a case, it is assumed that the same processing as the normal image processing in S108 is executed in parallel with the same processing as the special image processing in S107. In the same processing as the special image processing in S107 in such a case, it is assumed that the special image processing is executed on not only an image that is set to be a partial image but also an image that is set to be an input image. In the same processing as the display processing in S109, it is assumed that the display of the image after the normal image processing, the enlarged display of the partial image after the special image processing, and the display of the input image after the special image processing are performed in the same screen of the display device 202. It is assumed that a rectangular frame designated as an enlargement target region is superimposed and displayed on the image after the normal image processing in such a case.

In each of the display screens illustrated in FIGS. 13A, 13B, and 13C, the image on the left (“luminance-enhanced enlarged display” image) is an enlarged display of a partial image after special image processing, the image on the upper right (“normal display” image) is an image after normal image processing on which a rectangular frame designated as an enlargement target region is superimposed, and the image on the lower right (“luminance-enhanced display” image) is an input image after special image processing.

A display screen 241 illustrated in FIG. 13A is a display screen in a case where the partial image corresponding to the enlargement target region designated by a rectangular frame 242 is the partial image 211 illustrated in FIG. 12A and the processing is performed with the highest luminance range F among the luminance ranges D, E, and F as the luminance range to be enhanced. In the images after the special image processing (the “luminance-enhanced enlarged display” image and the “luminance-enhanced display” image) in this case, the pixels having the brightness corresponding to the luminance range F are displayed in white, and the other pixels are displayed in black, so that the observation site represented by the pixels having the brightness corresponding to the luminance range F is enhanced and displayed.

A display screen 243 illustrated in FIG. 13B is a display screen in a case where the partial image corresponding to the enlargement target region designated by a rectangular frame 244 is the partial image 221 illustrated in FIG. 12B and the processing is performed with the intermediate luminance range E among the luminance ranges D, E, and F as the luminance range to be enhanced. In the images after the special image processing (the “luminance-enhanced enlarged display” image and the “luminance-enhanced display” image) in this case, the pixels having the brightness corresponding to the luminance range E are displayed in white, and the other pixels are displayed in black, so that the observation site represented by the pixels having the brightness corresponding to the luminance range E is enhanced and displayed.

A display screen 245 illustrated in FIG. 13C is a display screen in a case where the partial image corresponding to the enlargement target region designated by a rectangular frame 246 is the partial image 231 illustrated in FIG. 12C and the processing is performed with the lowest luminance range D among the luminance ranges D, E, and F as the luminance range to be enhanced. In the images after the special image processing (the “luminance-enhanced enlarged display” image and the “luminance-enhanced display” image) in this case, the pixels having the brightness corresponding to the luminance range D are displayed in white, and the other pixels are displayed in black, so that the observation site represented by the pixels having the brightness corresponding to the luminance range D is enhanced and displayed.

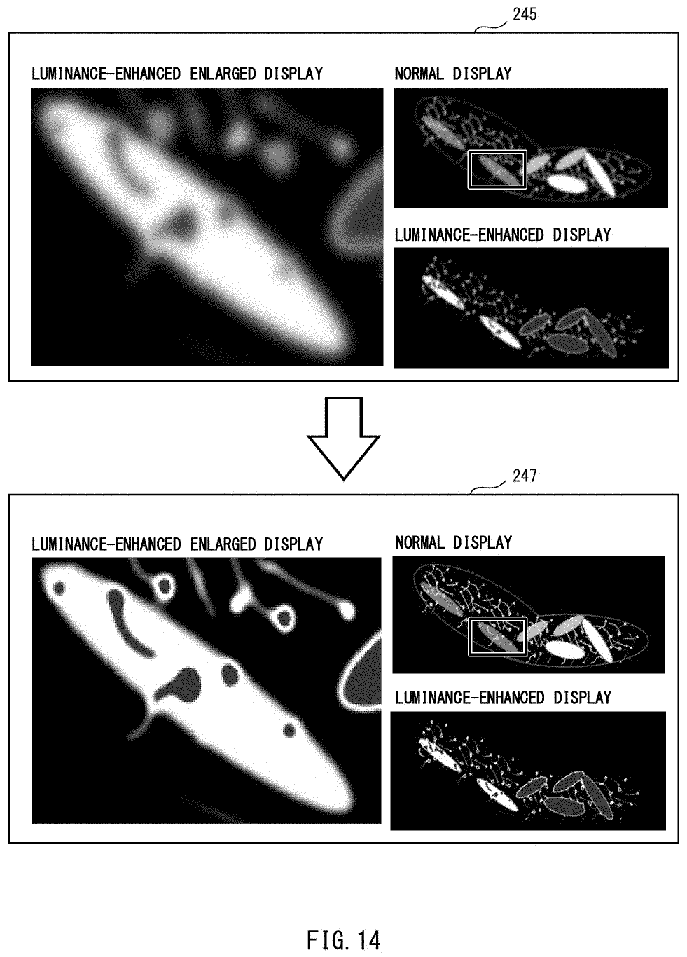

FIG. 14 is a diagram illustrating an example of a case where the user performs manual focusing while viewing the display screen 245 illustrated in FIG. 13C.

As illustrated in FIG. 14, in the image after the special image processing of the display screen 245 (the “luminance-enhanced enlarged display” image and the “luminance-enhanced display” image), the observation site represented by the pixels having the brightness corresponding to the luminance range D is enhanced and displayed, so that the user can distinguish the observation site having the brightness corresponding to the luminance range D and easily perform manual focusing on the observation site. The display screen 247 is a display screen after manual focusing, and an image focused on an observation site having the brightness corresponding to the luminance range D is obtained.

As described above, according to the second embodiment, the user can distinguish an observation site of a specific brightness during fluorescence observation, and can easily perform manual focusing on the observation site.

In the microscope system 200 according to the second embodiment, the control unit included in the microscope main body 201 can be implemented by, for example, a computer and a program executed by the computer.

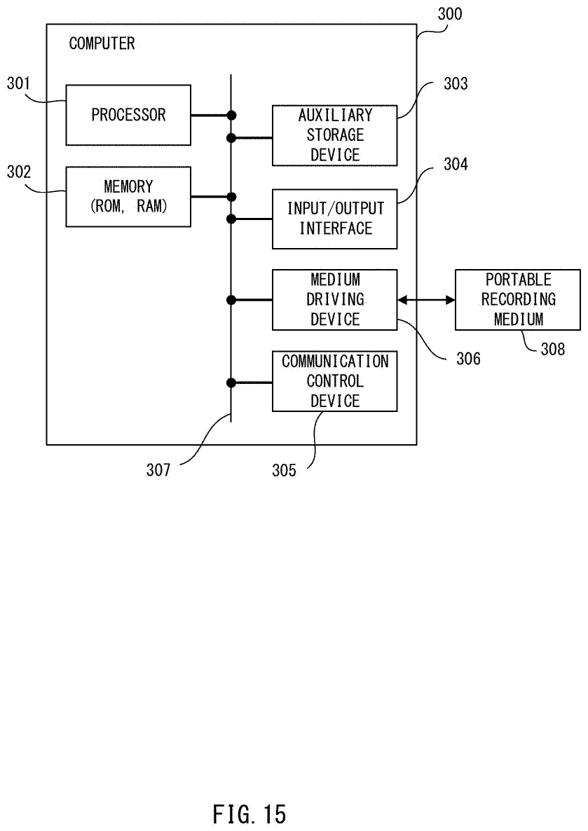

FIG. 15 is a diagram illustrating a hardware configuration of the computer.

As illustrated in FIG. 15, the computer 300 includes a processor 301 such as a CPU, a memory 302, an auxiliary storage device 303, an input/output interface 304, a communication control device 305, and a medium driving device 306, and these elements are interconnected by a bus 307 so that data can be transmitted and received between the elements.

The processor 301 controls the overall operation of the computer 300 by executing a program. The memory 302 includes a ROM and a RAM, which are not illustrated. A program or others executed by the processor 301 is recorded in advance in the ROM of the memory 302. The RAM of the memory 302 is used as a work area or other areas of the processor 301.

The auxiliary storage device 303 is, for example, a magnetic disk such as a hard disk drive (HDD) or a nonvolatile memory such as a flash memory. The auxiliary storage device 303 can store a program or others to be executed by the processor 301.

The input/output interface 304 connects the computer 300 to a part of the microscope main body 201, the display device 202, the input device 203, and others.

The communication control device 305 is a device that connects the computer 300 to a network and controls communication between the computer 300 and other electronic devices via the network.

The medium driving device 306 reads programs or data recorded in a portable recording medium 308 and writes data and others stored in the auxiliary storage device 303 to the portable recording medium 308. Examples of the portable recording medium 308 include an SD memory card. The portable recording medium 308 can be used to store the above-described program and others. When the computer 300 is mounted with an optical disk drive that can be used as the medium driving device 306, various optical disks that can be recognized by the optical disk drive can be used as the portable recording medium 308. Examples of an optical disc that can be used as the portable recording medium 308 include a compact disc (CD), a digital versatile disc (DVD), and a Blu-ray disc (Blu-ray is a registered trademark).

The control unit 107 of the imaging apparatus 100 according to the first embodiment can be similarly implemented by a computer and a program executed by the computer.

While the embodiments have been described above, the present invention is not limited to the embodiments as they are. The present invention can be embodied by modifying components without departing from the gist thereof at the stage of implementation. Various inventions can be formed by appropriately combining a plurality of components disclosed in the above embodiments. For example, some of all the components illustrated in the embodiments may be deleted. Furthermore, components in different embodiments may be combined as appropriate.

In the above embodiment (including a modified example), a digital camera is used as an apparatus for photographing, but the camera may be a digital single-lens reflex camera, a mirrorless camera, a compact digital camera, a moving image camera such as a video camera or a movie camera, a camera incorporated in a mobile phone, a smartphone, a personal digital assistant, a personal computer (PC), a tablet computer, a game device, or others, a medical camera (e.g., a medical endoscope or a laparoscope), a camera for scientific instruments such as a microscope, an industrial endoscope, a camera mounted on an automobile, or a monitoring camera. In any case, any photographing device may be used as long as the device can have the function of performing the gradation processing described in the above embodiment.

In the above embodiment (including a modified example), the case where the manual focusing is performed has been described as an example, but the same processing may be performed in a case where automatic focusing is performed. In this case, for example, the imaging apparatus 100 (the control unit 107 or others) may perform focus adjustment based on the image outputted from the special image processing unit 110. For example, the microscope main body 201 (a control unit or others of the microscope main body 201) may perform focus adjustment based on an image outputted from the same function as that of the special image processing unit 110 included in the control unit.

What is claimed is:

1. An image processing device comprising:
a division circuit configured to divide an input image or a partial image that is a part of the input image into a plurality of block images;
a detection circuit configured to detect brightness of each of the plurality of block images;
a determination circuit configured to determine a brightness range to be enhanced based on brightness of each of the plurality of block images;
a gradation processing circuit configured to perform gradation processing on the input image or the partial image so that brightness of a pixel having brightness included in the brightness range to be enhanced is enhanced; and
an output circuit configured to output an image after the gradation processing, wherein
the gradation processing circuit performs gradation processing on the input image or the partial image so that brightness of a pixel having brightness included in the brightness range to be enhanced is enhanced and brightness of a pixel having brightness not included in the brightness range to be enhanced is suppressed and so that a gradation value of a pixel having brightness included in the brightness range to be enhanced is set to a first gradation value and a gradation value of a pixel having brightness not included in the brightness range to be enhanced is set to a second gradation value (however, second gradation value<first gradation value).

2. The image processing device according to claim 1, wherein
the first gradation value is set to a maximum value of an expressible gradation range, and
the second gradation value is set to a minimum value of the gradation range.

3. The image processing device according to claim 1, wherein
the detection circuit detects luminance of each of the plurality of block images as brightness of each of the plurality of block images.

4. The image processing device according to claim 1, wherein
the detection circuit detects a G component of each of the plurality of block images as brightness of each of the plurality of block images.

5. The image processing device according to claim 3, wherein
the detection circuit detects, as luminance of each of the plurality of block images, an average value of luminance values of pixels included in the block images for each of the plurality of block images.

6. The image processing device according to claim 4, wherein
the detection circuit detects, as a G component of each of the plurality of block images, an average value of G component values of pixels included in the block images for each of the plurality of block images.

7. The image processing device according to claim 1, wherein
the determination circuit specifies, among the plurality of block images, a block image having brightness included in any of a plurality of different brightness ranges and being closest to a center of the input image or the partial image, and determines a brightness range including brightness of the specified block image among the plurality of brightness ranges as the brightness range to be enhanced.

8. The image processing device according to claim 1, wherein
the determination circuit determines whether or not brightness of each of the plurality of block images is included in any of a plurality of different brightness ranges, counts block images in number having brightness included in the brightness range for each brightness range of the plurality of brightness ranges, and determines any of the plurality of brightness ranges as the brightness range to be enhanced based on the number of block images for each brightness range.

9. The image processing device according to claim 8, wherein
the determination circuit determines, among the plurality of brightness ranges, a brightness range having the block images which are largest in number as the brightness range to be enhanced.

10. The image processing device according to claim 1, further comprising
a monochrome conversion circuit configured to convert an image after the gradation processing to monochrome without changing gradation to generate a monochrome image, wherein
when a monochrome image is generated by the monochrome conversion circuit, the output circuit outputs the monochrome image instead of an image after the gradation processing.

11. The image processing device according to claim 1, further comprising
a region designation circuit configured to designate a partial region of the input image, wherein
the partial image is an image of a region designated by the region designation circuit.

12. The image processing device according to claim 1, wherein
the image processing device is provided in an imaging apparatus, the imaging apparatus comprising:
an imaging processing circuit configured to image a subject field and output imaging data;
an image generation circuit configured to generate an image based on the imaging data; and
a display device,
an image generated by the image generation circuit is inputted to the image processing device as the input image, and
the display device displays an image outputted from the image processing device.

13. The image processing device according to claim 12, wherein
the display device enlarges and displays an image outputted from the image processing device.

14. The image processing device according to claim 12, wherein
the imaging apparatus further comprises
a scene determination circuit configured to determine a subject field scene to be photographed, and
the image processing device operates only when the scene determination circuit determines that the subject field scene is an astronomical scene.

15. The image processing device according to claim 12, wherein
the imaging apparatus further comprises
a gradation processing circuit configured to perform normal gradation processing on an image generated by the image generation circuit, and
the display device alternately displays an image outputted from the image processing device, and an image after the normal gradation processing or a partial image which is a part of an image after the normal gradation processing and corresponds to an image outputted from the image processing device.

16. The image processing device according to claim 12, wherein
the imaging apparatus further comprises
an interface to which an image is inputted, and
the imaging apparatus inputs an image inputted to the interface to the image processing device as the input image.

17. The image processing device according to claim 12, wherein
the imaging apparatus performs focus adjustment based on an image outputted from the image processing device.

18. An image processing method comprising:
dividing an input image or a partial image that is a part of the input image into a plurality of block images;
detecting brightness of each of the plurality of block images;
determining a brightness range to be enhanced based on brightness of each of the plurality of block images;
performing gradation processing on the input image or the partial image so that brightness of a pixel having brightness included in the brightness range to be enhanced is enhanced; and
outputting an image after the gradation processing, wherein
the gradation processing performs gradation processing on the input image or the partial image so that brightness of a pixel having brightness included in the brightness range to be enhanced is enhanced and brightness of a pixel having brightness not included in the brightness range to be enhanced is suppressed and so that a gradation value of a pixel having brightness included in the brightness range to be enhanced is set to a first gradation value and a gradation value of a pixel having brightness not included in the brightness range to be enhanced is set to a second gradation value (however, second gradation value<first gradation value).

19. The image processing method according to claim 18, wherein
the determination specifies, among the plurality of block images, a block image having brightness included in any of a plurality of different brightness ranges and being closest to a center of the input image or the partial image, and determines a brightness range including brightness of the specified block image among the plurality of brightness ranges as the brightness range to be enhanced.

20. A non-transitory recording medium recording a program for causing a computer to execute a process, the process comprising:
dividing an input image or a partial image that is a part of the input image into a plurality of block images;
detecting brightness of each of the plurality of block images;
determining a brightness range to be enhanced based on brightness of each of the plurality of block images;
performing gradation processing on the input image or the partial image so that brightness of a pixel having brightness included in the brightness range to be enhanced is enhanced; and
outputting an image after the gradation processing, wherein
the gradation processing performs gradation processing on the input image or the partial image so that brightness of a pixel having brightness included in the brightness range to be enhanced is enhanced and brightness of a pixel having brightness not included in the brightness range to be enhanced is suppressed and so that a gradation value of a pixel having brightness included in the brightness range to be enhanced is set to a first gradation value and a gradation value of a pixel having brightness not included in the brightness range to be enhanced is set to a second gradation value (however, second gradation value<first gradation value).
